(19) United States
(12) Patent Application Publication
(10) Pub. No.: US 2005/0005411 A1
(43) Pub. Date: Jan. 13, 2005

(54) Method for manufacturing tuning fork type piezoelectric device and tuning fork type piezoelectric device

(75) Inventors: Osamu Kawauchi, Shiojiri-shi (JP); Masayuki Kikushima, Inashi (JP); Yoshio Morita, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/833,006

(22) Filed: Apr. 28, 2004

(30) Foreign Application Priority Data
May 7, 2003 (JP) 2003-129184

(51) Int. Cl. H04R 17/00

(52) U.S. Cl. 29/25.35; 29/25.42

(57) ABSTRACT

A method for manufacturing a tuning fork type piezoelectric device 10 includes a step of mounting a tuning fork type piezoelectric vibrating element 16 to a package base 12 having a sealing hole 20 with a conductive adhesive 14 having a Young's modulus of 1×10⁻² GPa and below, a step of bonding a lid member 18 to an upper surface of the package base 12 with a low melting point glass 30, a step of a vacuum sealing the sealing hole 20 with a sealing member after vacuuming the inside of the package 28 through the sealing hole 20, and a step of adjusting a frequency by irradiating laser light to the tuning fork type piezoelectric vibrating element 16 through the lid member 18.

### BACKGROUND OF THE INVENTION

1. Field of Invention

The present invention relates to a manufacturing method for a tuning fork type piezoelectric device and the tuning fork type piezoelectric device more particularly, the invention relates to a manufacturing method for a tuning fork type piezoelectric device, and a tuning fork type piezoelectric device in which both are suitable for vacuum sealing a package without a deterioration of a frequency characteristic.

2. Description of Related Art

A related art tuning fork type piezoelectric device is capable of achieving an accurate frequency. The related art tuning fork type piezoelectric device can be employed as a detecting element of a gyro sensor used to detect object position or an attitude control. Such a tuning fork type piezoelectric device can provide a small and thin devices such as small and thin electronic equipment, by using a so-called surface mount type of tuning fork type piezoelectric device. In the tuning fork type piezoelectric device of this surface mount type, a tuning fork type piezoelectric element is mounted so as to be parallel with a base of a package base and supported in cantilever fashion on the package base.

In the tuning fork type piezoelectric device, a lid member is bonded, on an upper part of the package base in which the tuning fork type piezoelectric element is mounted, with a low melting point glass. Since a bonding of the lid member is performed under heating at 320 degrees centigrade to 370 degrees centigrade, an inside of the package also becomes high, temperature similarly to the bonding temperature. Consequently, only a polyimide based conductive adhesive, whose heat-resistant temperature is high, can be used for the conductive adhesive to mount the tuning fork type piezoelectric element to the package base, since any conductive adhesive whose heat-resistant temperature is lower than the bonding temperature cannot be used. However, since the polyimide based conductive adhesive, which has a high hardness, bonds and fixes a base of the tuning fork type piezoelectric element solidly on the package base, when the tuning fork type piezoelectric vibrating element performs a bending vibration, the vibration propagates through the base causing the deterioration of the frequency characteristic, thereby increasing a crystal impedance value.

Also, if a quartz crystal is used for a material of the piezoelectric vibrating element, the tuning fork type piezoelectric vibrating element vibrates in a flexural mode (32.768 kHz) that is its main vibration. In this tuning fork type piezoelectric vibrating element, if a solder-type or an epoxy-type is used for the conductive adhesive so as to support it in the cantilever fashion, a Young's modulus of these conductive adhesives is close to an asymmetric mode (x-mode) being in an X-axis direction that is a piezoelectric crystal axis. Therefore, the flexural vibration of the tuning fork type piezoelectric element is influenced by the x-mode to lose energy, thereby deteriorating the frequency characteristic. However, the flexural vibration is not adversely affected by another vibration, such as the x-mode or the like, if the conductive adhesive having the Young's modulus of 1×10⁻² GPa and below is applied. For the conductive adhesive having the Young's modulus of 1×10⁻² GPa and below, a silicon based and a butadiene based conductive adhesive are exemplified.

A technique to mount the piezoelectric vibrating element to the package base by using the silicon based conductive adhesive includes the technique described in Japanese Unexamined Patent Publication Application No. Tokukaihei 10-256409. This technique demonstrates that the piezoelectric vibrating element is mounted to the package base with the silicon based conductive adhesive. Then the lid member is bonded on the package base with the low melting point glass so as to keep the package in an airtight state. Also, when the lid member is bonded to the package base, the lid member is bonded on the package base by heating of the lid member at a higher temperature than a melting point of the low melting point glass in a nitrogen atmosphere, while spacing the lid member sufficiently apart from the package base. This techniques shows that the lid member can be bonded to the package base by using the low melting point glass without the deterioration of the silicon based conductive adhesive.

### SUMMARY OF THE INVENTION

However, the technique described in Japanese Unexamined Patent Publication Application No. Tokukaihei 10-256409 cannot be utilized for the piezoelectric device where the package is required to keep an inside vacuum since a heating and sealing process for the lid member are carried out in the nitrogen atmosphere. Specifically, the tuning fork type piezoelectric vibrating element employs the flexural mode. Thereby a problem occurs that an air resistance adversely affects the crystal impedance value in the case of the flexural vibration in the nitrogen atmosphere. Accordingly, the tuning fork type piezoelectric device is required to vacuum seal the inside of the package. Also, in the technique described in Japanese Unexamined Patent Publication Application No. Tokukaihei 10-256409, a gas is produced from the low melting point glass or the like, even if the heating and sealing process for the lid member are carried out in the vacuum instead of in the nitrogen atmosphere. Consequently, in this technique, the gas produced from the low melting point glass or the like remains inside of the package when the lid member and the package base are bonded, thereby being not able to vacuum seal the package.

Also, the method to vacuum seal the package includes a single sealing method as follows: a gold-tin braze that becomes a sealing member is preformed on a peripheral part of the lid member; the lid member is bonded to the package base by heating at a temperature higher than the melting point of gold-tin sealing member (approximately 280 degrees centigrade). However, there was the constraint that the conductive adhesive that does not deteriorate at high temperature was required for the adhesive mounting of the tuning fork type piezoelectric vibrating element to the package base since the lid member is heated at a temperature higher than the melting point of the gold-tin sealing member. Also, since the gas produced from the sealing member or the package or the like cannot be completely removed, it was difficult to reduce the crystal impedance value. In addition, there is a problem that the gold-tin sealing member became costly because it contained the gold.

In order to address the above-mentioned and/or other problems, an exemplary embodiment of the present invention provides a method to manufacture a tuning fork type piezoelectric device and a tuning fork type piezoelectric device in which both are capable of vacuum sealing the package by bonding the package base and the lid member with the low melting point glass, even if the conductive adhesive that is suitable to mount the tuning fork type piezoelectric vibrating element to the package base is employed.

In order to address or achieve the above, a method to manufacture a tuning fork type piezoelectric device according to an aspect of the invention includes mounting a tuning fork type piezoelectric vibrating element to a package base having a sealing hole with a conductive adhesive having a Young's modulus of 1×10⁻² GPa and below, bonding a lid member to an upper surface of the package base with a low melting point glass, vacuum sealing the sealing hole with a sealing member after vacuumizing an inside of the package by using the sealing hole, and adjusting a frequency by irradiating laser light to the tuning fork type piezoelectric vibrating element through the lid member. In this case, for the conductive adhesive having a Young's modulus of 1×10⁻² GPa and below, at least one of a butadiene based conductive adhesive and a silicon based conductive adhesive can be used.

In this way, while a gas is produced when the lid member is bonded to the package base, a vacuum that is suitable for a flexural vibration of the tuning fork type piezoelectric vibrating element can be achieved inside the package because a sealing is performed by vacuuming the inside of the package after bonding the lid member. In addition, since a material having a Young's modulus of 1×10⁻² GPa and below is used for the conductive adhesive, the conductive adhesive can absorb a vibration even though the tuning fork type piezoelectric vibrating element performs the flexural vibration. Also, an aspect of this invention can achieve the tuning fork type piezoelectric vibrating element having a high accurate frequency since the frequency of the tuning fork type piezoelectric vibrating element is adjusted after vacuum sealing the package.

In an aspect of the invention, the material of the lid member is glass. Since the lid member made of the glass transmits the laser light to adjust the frequency of the tuning fork type piezoelectric vibrating element, the frequency adjustment of the tuning fork type piezoelectric vibrating element can be done after bonding the lid member to the package base.

In an aspect of the invention, the tuning fork type piezoelectric vibrating element includes a groove along a longitudinal direction of both surfaces of a vibration arm part. In an aspect of this invention, as described above, an enhancement of an efficiency of the flexural vibration of the vibration arm part leads to a decreasing of the crystal impedance (CI) value, thereby enabling the tuning fork type piezoelectric vibration element to be configured in the small scale.

The sealing hole is configured by a first hole part and a second hole part having an opening being smaller than that of the first hole part. Both are coated with a metal. A sealing member is placed to the first hole part and melted, enabling the sealing hole to seal by being melted and bonded to the metal coating.

The sealing member is characterized in that it is a metal ball using a material that is at least one of gold-tin, a gold-germanium, and a silver braze. Since these sealing members wet over the metal coating when they are melted, the sealing hole can be sealed without an extrusion of the sealing members inside the package.

The tuning fork type piezoelectric device according to an aspect of the invention is manufactured by the above-mentioned method to manufacture the tuning fork type piezoelectric device. Accordingly, since the conductive adhesive absorbs a vibration even though the tuning fork type piezoelectric vibrating element performs the flexural vibration, there is no vibration leakage to an outside. Therefore, the tuning fork type piezoelectric device can perform the stable flexural vibration.

In an aspect of the invention the above-mentioned tuning fork type piezoelectric device mounts a semiconductor integrated circuit. Accordingly, this makes it possible to achieve a stable tuning fork type piezoelectric device.

### BRIEF DESCRIPTION OF THE DRAWINGS

FIG. 1 is a schematic of a tuning fork type piezoelectric device according to an exemplary embodiment;

FIG. 2 is a flow describing a manufacturing process of the tuning fork piezoelectric device according to an exemplary embodiment;

FIG. 3 is a schematic comparing a crystal impedance of the tuning fork type piezoelectric device according to an exemplary embodiment and a tuning fork type piezoelectric device according to a related art;

FIG. 4 is a schematic illustrating a measurement result of a vibration leakage of the tuning fork type piezoelectric device according to an exemplary embodiment;

FIG. 5 is a schematic illustrating a measurement result of a vibration leakage of the tuning fork type piezoelectric device due to a difference in the conductive adhesives;

FIG. 6 is a schematic illustrating a metal coating provided to a sealing hole according to the exemplary embodiment;

FIG. 7 is a schematic illustrating another example of the metal coating provided to the sealing hole according to an exemplary embodiment;

FIG. 8 is a schematic illustrating a tuning fork type piezoelectric vibrating element according to another exemplary embodiment;

FIG. 9 is a schematic taken along plane A-A in FIG. 8; and

FIG. 10 is a schematic describing a sealing method of the sealing hole.

### DETAILED DESCRIPTION OF EXEMPLARY EMBODIMENTS

A method to manufacture a tuning fork type piezoelectric device and the tuning fork type piezoelectric device according to an exemplary embodiment the invention will be described below. Here, the described below is merely one aspect of the exemplary embodiment of the invention. The present invention is not limited to this.

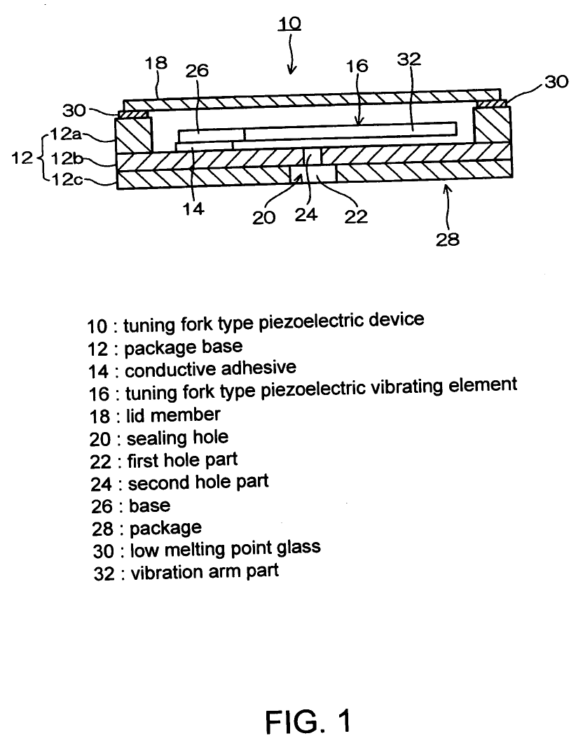

FIG. 1 is a schematic illustrating the tuning fork type piezoelectric device according to the invention. A tuning fork type piezoelectric device 10 is made up of the tuning fork type piezoelectric vibrating element 16 mounted to a package base 12 with a conductive adhesive 14 and a lid member 18 bonded on an upper part of the package base 12.

The package base 12 is made up of a frame like a ceramic insulating substrate stacked on a plurality of planar shaped ceramic insulating substrates. In this package base 12, a sealing hole 20 having a two-step configuration is provided to a bottom surface. Performing a press working, or the like, to the planar shaped ceramic substrate making up the bottom surface forms the sealing hole 20. The sealing hole 20 configures a first hole part 22 and a second hole part 24. In the sealing hole 20, the first hole part 22 is provided to the ceramic substrate of a third layer 12c being the bottom surface of the package base 12, and the second hole part 24 is provided to the ceramic substrate of a second layer 12b being an inside face of the package base 12. An opening of the second hole part 24 is formed smaller than that of the first hole part 22. Also, the center of the opening of the first hole part 22 and second hole part 24 are aligned so as to be nearly same position.

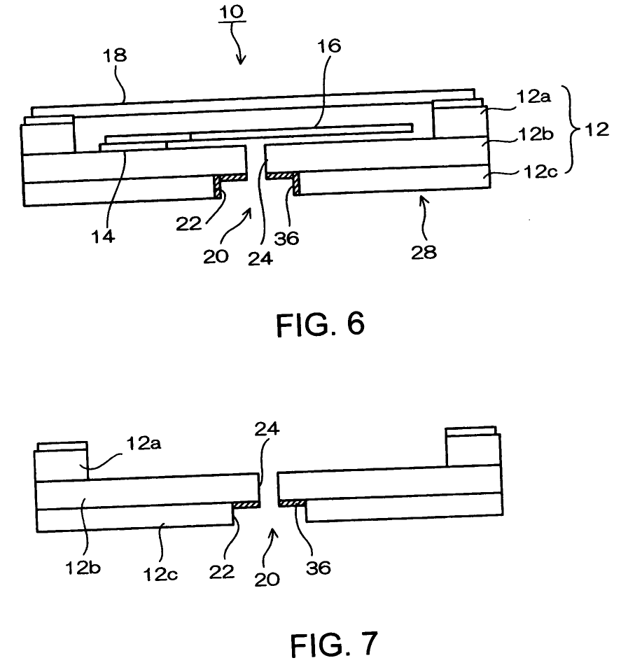

For the sealing hole 20 of this exemplary embodiment, as shown in FIG. 6, a metal coating 36 that is made up of a tungsten-metalized, on which nickel and gold are plated, is provided. The metal coating is formed on a bottom surface of the second layer 12b that is a bottom surface of the first hole part 22 having a large diameter and on a side surface of the third layer 12c that is a circumferential surface of the first hole part 22. However, the metal coating 36 is not formed on a circumferential surface of the second hole part 24. This is to prevent the sealing member made up of a metal described later from dripping off and into the package 28.

In this way, since the metal coating 36 is formed on the bottom surface of the second layer 12b and on the side surface of the third layer 12c in this exemplary embodiment, if the sealing member made up of a metal ball described later is melted, the sealing member wets and spreads on along the metal coating 36 so as to be melted and bonded, thereby enabling the sealing hole 20 to be sealed satisfactory. The metal coating 36 may be provided merely on the bottom surface of the second layer 12b as shown in FIG. 7.

A package side mount electrode (not shown) is formed on an inside surface of the package base 12 so as to mount the tuning fork type piezoelectric vibrating element 16. The mount electrode is electrically connected to an outer electrode (not shown) formed on the bottom surface of the package base 12.

The tuning fork type piezoelectric vibrating element 16 is made up of a base 26 and a pair of arms 32. A connecting electrode (not shown) formed on the base 26 and the mount electrode are bonded and fixed with a conductive adhesive 14 so as to be mounted on the inside of a package 28. For the conductive adhesive 14, the material having the Young's modulus of 1×10⁻² GPa and below, for example, such as the butadiene based conductive adhesive and the silicon based conductive adhesive can be used. The Young's modulus of the butadiene based conductive adhesive is approximately 1×10⁻² GPa. The Young's modulus of the silicon based conductive adhesive is approximately 1×10⁻³ GPa.

Also, a lid member 18 is bonded on the upper surface of the package base 12, specifically on the first ceramic insulating substrate 12a shaped to be frame like, with a low melting point glass 30 being the sealing member. The lid member 18 employs a material that laser light transmits through, for frequency adjustment of the tuning fork type piezoelectric vibrating element. For example, glass, sapphire, or the like.

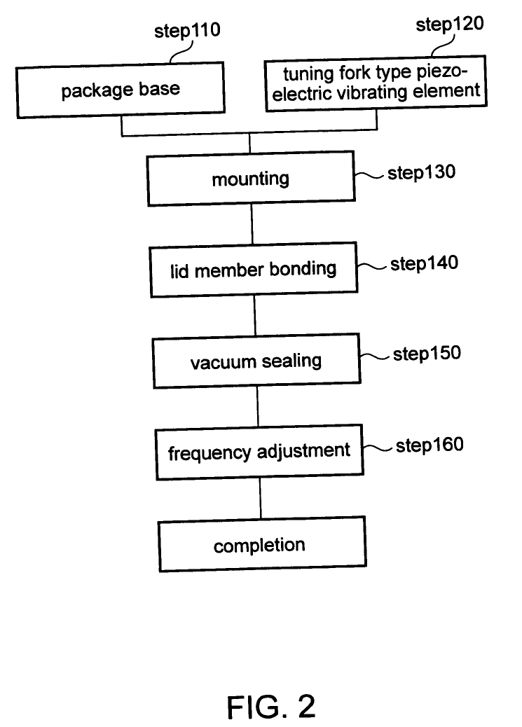

Next, a method to manufacture a tuning fork type piezoelectric device 10 will be described. FIG. 2 is a flowchart describing the manufacturing process of the tuning fork type piezoelectric device 10. The package base 12 of the tuning fork type piezoelectric device 10 is made of the stacked layers of the plurality of ceramic substrates as described above. The hole part 22 and 24 each having an opening of different size are formed by performing the press working or the like on the second layer 12b and third layer 12c that both make up of the bottom surface of the package base 12 and are made of a planar shaped ceramic substrate. The hole part 22 and 24 make up a sealing hole 20. A metal coating 36 is formed on the bottom surface and the circumferential surface of the first hole part 22 by a thick film printing, plating or the like (refer to FIG. 6). Also, the package side mount electrode (not shown) is provided on the upper surface of the second layer 12b. The outer electrode (not shown) is provided on the bottom surface of the third layer 12c. These electrodes are made up of a tungsten layer, for example, formed by the thin film printing or the like, thereby plating nickel and gold on the tungsten layer. For the package 12, the frame like ceramic insulating substrate being the first layer 12a is stacked on the second layer 12b of the ceramic insulating substrate to unify them by firing (step 110).

In addition, for the tuning fork type piezoelectric vibrating element 16, an excitation electrode (not shown) formed on a vibrating arms part 32 and the connecting electrode that connects the excitation electrode and is formed on the base 26 of the tuning fork type piezoelectric vibrating element 16 are formed by a film forming, such as a sputtering, deposition, or the like (step 120). These electrodes are formed by, for example, depositing gold on chromium.

In the package base 12 formed as above-mentioned, the tuning fork type piezoelectric vibrating element 16 is mounted with the conductive adhesive 14 having a Young's modulus of 1×10⁻² GPa and below (step 130). At this time, the connecting electrode is bonded and fixed on the mount electrode of the package base 12 such that the tuning fork type piezoelectric vibrating element 16 is supported in cantilever fashion. Additionally, the butadiene based conductive adhesive or the silicon based conductive adhesive can be used as the conductive adhesive 14 having a Young's modulus of 1×10⁻² GPa and below. Then, heating at 200 degrees centigrade for approximately one hour cures the conductive adhesive 14.

Next, the lid member 18 is bonded on the upper part of the package base 12 where the tuning fork type piezoelectric vibrating element 16 is mounted (step 140) with the low melting point glass 30. At this time, melting the low melting point glass 30 by heating at 320 degrees centigrade to 350 degrees centigrade bonds the lid member 18 on the upper part of the package base 12 so as to form the package 28.

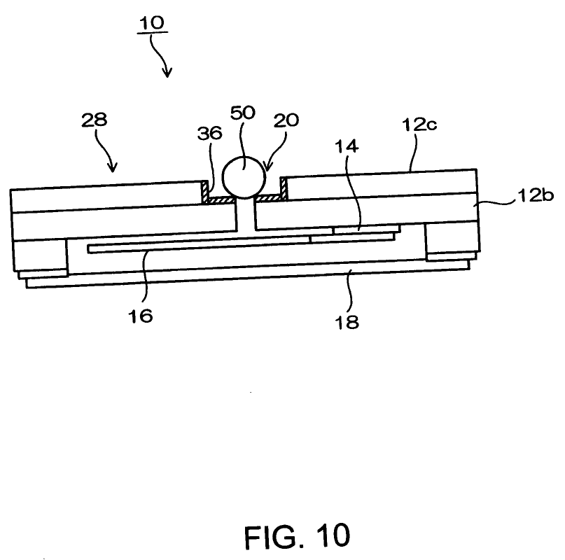

Next, the package 28 is set in a vacuum vessel, the vessel being evacuated. The package 28 is placed upside down as shown in FIG. 10. Accordingly, the inside of the package 28 is evacuated through the sealing hole 20 while reducing the pressure in the vessel. Then, a sealing member, 50 being the metal ball, is placed at the first hole part 22 of the sealing hole 20, thereby being melted by a local heating with the laser or an electron beam. The sealing member 50 melted wets on and spreads on the metal coating 36 so as to be melted and bonded, thereby vacuum sealing the sealing hole 20 (step 150).

For the sealing member 50, the metal ball made of gold-tin, gold-germanium, or silver braze or the like are used. With regard to a shape of the sealing member, a pellet in a plate-shape also can be used. If the sealing member is made of a gold-tin alloy, for example, an alloy containing 80 wt % gold and 20 wt % tin can be used. The melting point of the sealing member made of the gold-tin containing the above-mentioned composition is 278 degrees centigrade. In addition, if the sealing member 50 is the gold-germanium, an alloy containing 87.5 wt % gold and 12.5 wt % germanium can be used. The melting point of this gold-germanium sealing member is 361 degrees centigrade. Here, a vacuum degree inside the package 28 that has been vacuum sealed in step 150 is 0.13 Pa and below.

Next, a frequency of the tuning fork type piezoelectric vibrating element 16 mounted inside the package 12 is adjusted. Specifically irradiating laser light through the lid member 18 to a weight part (not shown) formed on a distal part of the vibrating arms 32 of the tuning fork type piezoelectric vibrating element 16 processes the weight part so as to adjust to a desired frequency (step 160), thereby forming the tuning fork type piezoelectric device 10.

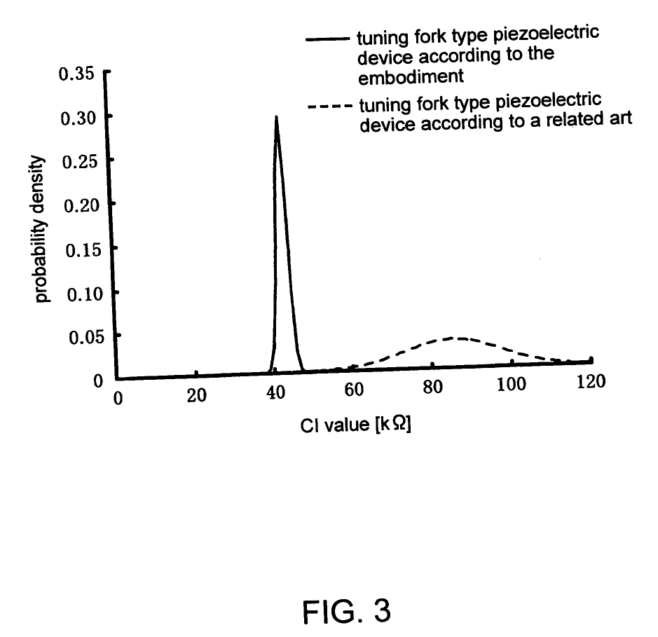

A distribution of the crystal impedance (CI) value of the tuning fork type piezoelectric device 10 formed as described above is measured. FIG. 3 shows the distribution of the CI value. In FIG. 3, the horizontal axis shows the CI value and the vertical axis shows a probability density. This schematic shows that the lower the CI value, the better the characteristics are. In addition, a solid line shows a measurement result of the tuning fork type piezoelectric device 10 manufactured by the above-mentioned method and a broken line shows a measurement result of the tuning fork type piezoelectric device 10 manufactured by the single sealing method being the related art. Here, the same tuning fork type piezoelectric vibrating element and silicon based conductive adhesive are used for these tuning fork type piezoelectric devices.

The tuning fork type piezoelectric device manufactured by the single sealing method shows that the CI value exceeds 80 kΩ with wide fluctuation. This nonconformity is due to gas generated when bonding of the lid member to the package base remains inside the package. This gas deteriorates the vacuum degree so as to prevent the tuning fork type piezoelectric vibrating element from vibrating in the flexural vibration. Therefore, the tuning fork type piezoelectric device manufactured by the single sealing method cannot be used as a commercial product.

The tuning fork type piezoelectric device 10 manufactured by the method of this exemplary embodiment shows that the CI value is stable at 50 kΩ on an average with low fluctuation. This advantage is due exhausting the gas generated inside the package 28 from the sealing hole 20, even if the gas is generated when bonding the lid member 18 to the package base 12. After that, if the inside of the package 28 is vacuum sealed by sealing the sealing hole 20 with the sealing member 50 being melted, the sealing can be carried out without generating gas substantially, because the heat is supplied only to the vicinity of the sealing hole 20. This enables the tuning fork type piezoelectric vibrating element 16 to stably vibrate in the flexural vibration without interference of the gas. In this way, it can be understood that the method to manufacture the tuning fork type piezoelectric device 10 of this exemplary embodiment has an edge on the related art single sealing method.

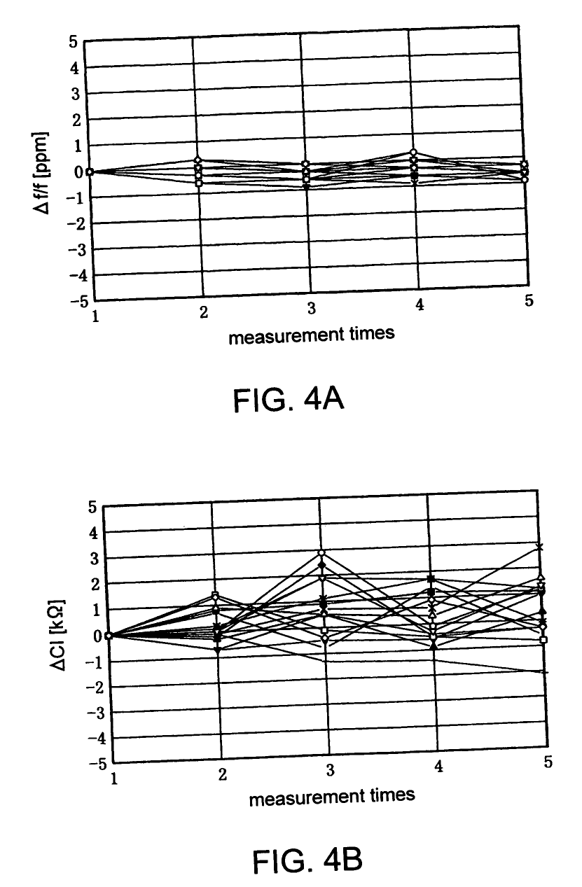

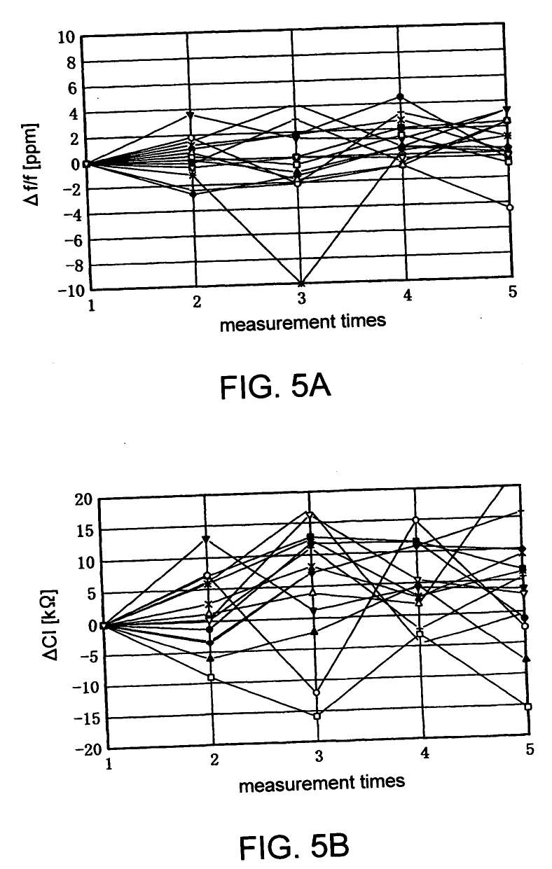

Next, in the tuning fork type piezoelectric device 10 manufactured by the method of this exemplary embodiment, a vibration leakage due to the difference in the conductive adhesives 14 is measured. The tuning fork type piezoelectric device 10 is repeatedly set to and reset from, a measuring circuit, a plurality of times. The vibration leakage is measured by measuring the frequency and CI value at each of the plurality of measurement times. A measuring method evaluates the variation at each of the measuring times that follows after the first time defined as the basis. FIG. 4 shows a measurement result of the vibration leakage of the tuning fork type piezoelectric device 10 that the tuning fork type piezoelectric vibrating element 16 is mounted on the package base 12 with the silicon based conductive adhesive. FIG. 5 shows the measurement result of the vibration leakage of the tuning fork type piezoelectric device 10 using the polyimide based conductive adhesive. FIG. 4(A) and FIG. 5(A) show the variation of the frequency at every measurement time. FIG. 4(B) and FIG. 5(B) show the variation of the CI value at every measurement time. In addition, the Young's modulus of the polyimide based conductive adhesive is approximately 3 GPa.

Comparing the case where the silicon based conductive adhesive is used and the case where the polyimide based conductive adhesive is used shows that the variation of the frequency and CI value at every measurement time is small and stable in the case where the silicon based conductive adhesive is used. By contrast, the variation of the frequency and CI value at every measurement time is large and not stable in the case where the polyimide based conductive adhesive is used. The silicon based conductive adhesive can absorb the flexural vibration of the tuning fork type piezoelectric vibrating element 16 and prevents the vibration from leaking outside, since its Young's modulus is approximately 1×10⁻³ GPa. Because of this, the tuning fork type piezoelectric vibrating element 16 stably performs the flexural vibration without any loss of a vibration energy, thereby occurring no variation at every measurement time.

In contrast, the polyimide based conductive adhesive, since its Young's modulus is approximately 3 GPa, cannot absorb the flexural vibration of the tuning fork type piezoelectric vibrating element. This leads to the vibration leakage to the outside, thereby causing the variation at every measurement time. The tuning fork type piezoelectric vibrating element cannot perform the stable flexural vibration by losing the vibration energy due to the vibration leakage to the outside. Accordingly, it can be understood that the tuning fork type piezoelectric device 10 employing the silicon based conductive adhesive stably vibrates without any loss of the vibration as compared with the tuning fork type piezoelectric device employing the conductive adhesive having the Young's modulus of larger than 1×10⁻² GPa, such as the polyimide based conductive adhesive.

According to the exemplary embodiments, the conductive adhesive 14 mounting the tuning fork type piezoelectric vibrating element 16 to the package base 12 is the conductive adhesive 14 having the Young's modulus of 1×10⁻² GPa and below, such as the butadiene based conductive adhesive or the silicon based conductive adhesive. Because of this, the tuning fork type piezoelectric device 10 that is stable and free from the vibration leakage to the outside can be achieved, because the conductive adhesive absorbs the vibration even if the tuning fork type piezoelectric vibrating element 16 performs the flexural vibration.

While the gas is produced, since the lid member 18 is bonded to the upper part of the package base 12 with the low melting point glass 30, the gas is exhausted from the sealing hole 20 such that no gas remains inside the package 28 owing to providing the sealing hole 20 for the vacuum sealing to the bottom surface of the package base 12. In addition, the sealing member 50 is melted by a local heating so as to vacuum seal the sealing hole 20. This makes it possible to perform the vacuum sealing with no thermal influence to the package 28. Consequently, the tuning fork type piezoelectric vibrating element 16 vibrates with no influence of an air resistance, thereby leading to a low CI value. As a result, the tuning fork type piezoelectric device 10 that has high accuracy and is stable can be achieved.

Additionally, the lid member 18 is made up of the material transmitting the laser light, such as glass, sapphire, or the like. In the related art single sealing method, an initial frequency shows considerably wide distribution due to an influence of a stress variation and heating variation, since the package is sealed after the frequency adjustment of the tuning fork type piezoelectric vibrating element. By contrast, since the lid member 18 transmits the laser light, the frequency of the tuning fork type piezoelectric vibrating element 16 can be adjusted to high accuracy after the vacuum sealing of the package 28, thereby enabling the tuning fork type piezoelectric device 10 having a steady initial frequency to be achieved.

A semiconductor integrated circuit, such as an oscillation circuit, a temperature compensated circuit or the like may be mounted to the tuning fork type piezoelectric device 10 of this exemplary embodiment. This makes it possible to achieve the more stable tuning fork type piezoelectric device.

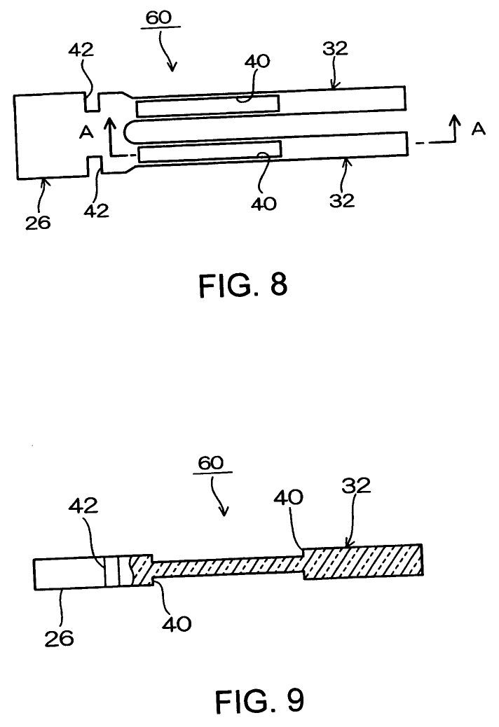

Also, in the tuning fork type piezoelectric vibrating element 16 of this exemplary embodiment, a groove showing a H-shaped cross-sectional form may be provided to the vibration arms 32 extended from the base 26. FIG. 8 and FIG. 9 are schematics of the tuning fork type piezoelectric vibrating element having the vibration arms to which the groove is provided. In these FIGS., the tuning fork type piezoelectric vibrating element 60 is made up of the base 26 and the pair of the vibration arms 32 extend from one end of the base 26. In the tuning fork type piezoelectric vibrating element 60, a rectangular-like groove part 40 is provided to a base end part side of the vibration arms 32. As shown in FIG. 9, the groove part 40 is formed at a corresponding position of the front face and back face of the vibrating arms 32. A sectional surface of the vibration arms 32 shows a H shape. Additionally, in the tuning fork type piezoelectric vibrating element 60, an excitation electrode (not shown) is formed on an inside surface of the groove part 40 and an opposed surface and an outer surface of each of the vibration arms 32. Accordingly, this enhances a vibration efficiency of the vibration arms 32, so that the tuning fork type piezoelectric vibrating element 60 exhibits a lower CI values than a related art one. Also, in the tuning fork type piezoelectric vibrating element 60, a rectangular groove 42 is formed at both side parts of the base 26 so as to reduce the vibration leakage from the base 26 when the tuning fork type piezoelectric vibrating element 60 is mounted.

The tuning fork type piezoelectric vibrating element 60, configured as described above, can reduce the CI value, because the vibration arms 32 introduces the H shape construction by forming the groove part 40. The deeper the depth of the groove part 40 is, the smaller the CI value is. Even if the vibrating arms 32 are formed thin, providing the groove part 40 to the vibrating arms 32 can reduce the CI value. Therefore, the tuning fork type piezoelectric vibrating element can be configured in a small scale, thereby enabling the tuning fork type piezoelectric device to be configured in the small scale. The outside dimension of the tuning fork type piezoelectric device having the groove part 40 is 3.2 mm×1.5 mm×0.8 mm, which is capable of achieving the 60 percent and below size of a related art tuning fork type piezoelectric device.

### INDUSTRIAL APPLICABILITY

The present invention can apply to a manufacturing of the tuning fork type piezoelectric device using for a wide variety of electronic equipment, such as communication equipment or the like, or for a sensor or the like.

1. A method to manufacture a tuning fork type piezoelectric device, comprising:
mounting a tuning fork type piezoelectric vibrating element to a package base including a sealing hole with a conductive adhesive having a Young's modulus of 1×10⁻² GPa and below;
bonding a lid member to an upper surface of the package base with a low melting point glass;
vacuum sealing the sealing hole with a sealing member after evacuating air from an inside of the package base via the sealing hole; and
adjusting a frequency by irradiating laser light to the tuning fork type piezoelectric vibrating element through the lid member.

2. The method to manufacture a tuning fork type piezoelectric device according to claim 1, the conductive adhesive having a Young's modulus of 1×10⁻² GPa and below being at least one of a butadiene based conductive adhesive and a silicon based conductive adhesive.

3. The method to manufacture a tuning fork type piezoelectric device according to claim 1, a material of the lid member being glass.

4. The method to manufacture a tuning fork type piezoelectric device according to claim 1, the sealing hole comprises a first hole part and a second hole part having an opening smaller than an opening of the first hole part, the first hole part and the second hole part being coated with a metal.

5. The method to manufacture a tuning fork type piezoelectric device according to claim 1, the sealing member being a metal ball made of a material comprising at least one of gold-tin, gold-germanium, and silver braze.

6. The method to manufacture a tuning fork type piezoelectric device according to claim 1, the tuning fork type piezoelectric vibrating element including a groove located along a longitudinal direction of both surfaces of a vibration arm part.

7. A tuning fork type piezoelectric device manufactured by using the method to manufacture a tuning fork type piezoelectric device according to claim 1.

8. The tuning fork type piezoelectric device according to claim 7, the tuning fork type piezoelectric device mounting a semiconductor integrated circuit.
